(19) United States
(12) Patent Application Publication
(10) Pub. No.: US 2013/0194197 A1
(43) Pub. Date: Aug. 1, 2013

(54) Electronic Apparatus With Touch Panel and the Operating Method Therefor

(71) Applicants: HUNG-YI LIN, New Taipei City (TW); KUO-HUA HSIUNG, Taipei (TW)

(72) Inventors: HUNG-YI LIN, New Taipei City (TW); KUO-HUA HSIUNG, Taipei (TW)

(73) Assignee: IDEACOM TECHNOLOGY INC., New Taipei City (TW)

(21) Appl. No.: 13/363,384

(22) Filed: Feb. 1, 2012

(51) Int. Cl. G06F 3/041

(52) U.S. Cl. 345/173

(57) ABSTRACT

The invention relates to an electronic apparatus with touch panel comprising a touch panel, a detecting module and a processing module. The detecting module coupled to the touch panel is used for detecting at least one first touch point and at least one second touch point on the touch panel and further detecting a vector difference between the at least one touch point and the at least one second touch point. The processing module coupled to the detecting module is used for executing a first command according to the at least one first touch point and executing a second command according to the vector difference and the first command.

### BACKGROUND OF THE INVENTION

1. Field of the Invention

The invention is related to an electronic apparatus with touch panel and the operating method therefor, and more specifically related to an electronic apparatus and the operating method therefor for executing command actions corresponding to multi-touch operations executed by a user on a touch panel with multi-touch function.

2. Description of the Prior Art

Various kinds of touch sensing technology are used in many different electronic products in recently years for its progress in better quality and more convenient. A touch panel is implemented in various kinds of electronic products because it has advantages in size small, cost less, power low and life durable.

It is trended to various functions of electronic products, touch panels of electronic products need supporting more operating gestures to execute the operated action correspondingly. Accordingly, the touch panel with multi-touch function is developed to enhance various functions of the electronic product with touch panel. Please refer to FIG. 1, FIG. 1 is a schematic diagram of an image scaling action of a touch panel with multi-touch function in the prior art. As shown as FIG. 1, when a user extends to scale an image object 12 displayed on a touch panel 10, the scaling method in general uses the touch panel 10 with multi-touch function to detect initial positions PS1, PS2 on the touch panel 10 touched by two fingers of the user and locks the image object 12 displayed on the touch panel 10 according to touched positions of the two fingers, and then generating parameter corresponding to a position difference between final positions PE1, PE2 and the initial position PS1, PS2 of the two fingers of the user. The image object scaling method further determines the scaling proportion of the image object 12 according to the parameter and finally adjusts the size of the image object 12 according to the scaling proportion to reach the image scaling function of the electronic product with the touch panel 10. However, it is a development trends at present for providing a fast and convenient touch panel 10 or electronic products with the touch panels 10.

According to the description described above, how to provide an electronic apparatus with touch panel and the operating method therefor for providing a fast and convenient touch panel has ability to detect operations executed by the user and operating the corresponding function actions is an important matter in developing the touch panel technology.

### SUMMARY OF THE INVENTION

It is therefore a primary objective of the present invention to provide an electronic apparatus with touch panel and the operating method therefor suited in operating multi-touch functions by the user and further executing the corresponding commands to execute function actions according to the multi-touch operations.

One embodiment of the present invention provides an electronic apparatus with touch panel comprising a touch panel, a detecting module and a processing module. The detecting module coupled to the touch panel is used for detecting at least one first touch point and at least one second touch point, and further determines a vector difference between the at least one first touch point and the at least one second touch point. The processing module coupled to the detecting module is used for executing a first command according to the at least one first touch point and executing a second command according to the vector difference and the first command.

The present invention further discloses an operating method of electronic apparatus with touch panel which comprising: (a) detecting at least one first touch point on a touch panel;(b) detecting at least one second touch point on the touch panel ;(c) determining a vector difference between the at least one first touch point and the at least one second touch point; (d) executing a first command according to the at least one first touch point; and (e) executing a second command according to the vector difference and the first command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image scaling action of a touch panel with multi-touch function in the prior art.

FIG. 2 is a schematic diagram of an embodiment of an electronic apparatus with touch panel according to the present invention.

FIG. 3 is a schematic diagram of an embodiment of a vector difference of the electronic apparatus with touch panel according to the present invention.

FIG. 4 is a schematic diagram of another embodiment of the vector difference of the electronic apparatus with touch panel according to the present invention.

FIG. 5 is a flowchart diagram of an embodiment of operating method of electronic apparatus with touch panel according to the present invention.

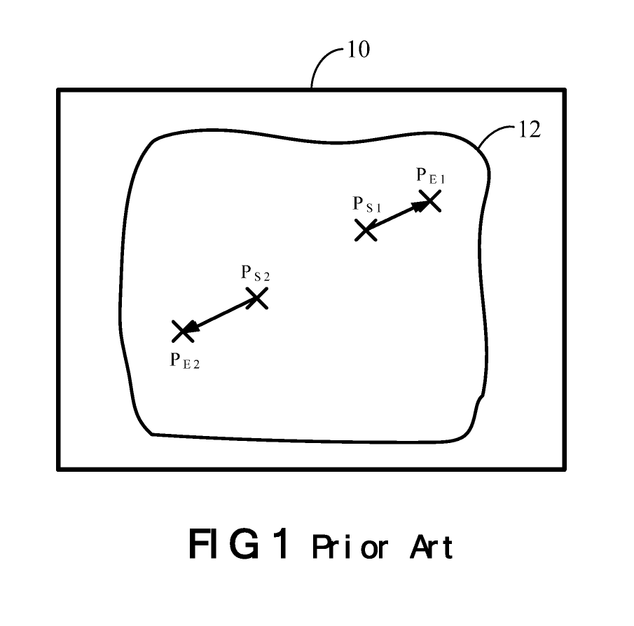

### DETAILED DESCRIPTION

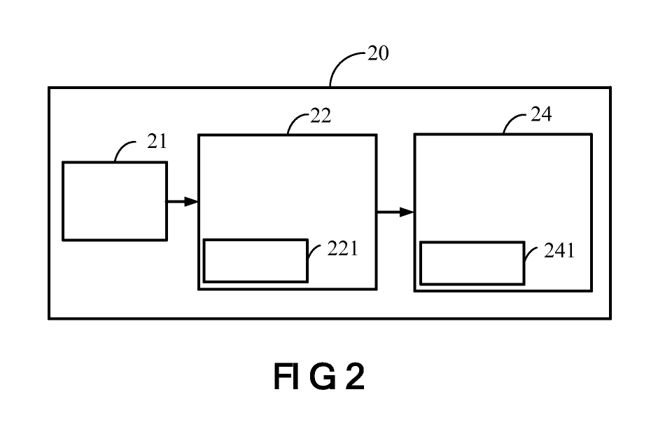

Please refer to FIG. 2. FIG. 2 is a schematic diagram of an embodiment of an electronic apparatus with touch panel according to the present invention. As shown in FIG. 2, the present invention provides an electronic apparatus 20 with touch panel 21 comprising a touch panel 21, a detecting module 22 and a processing module 24. The detecting module 22 coupled to the touch panel 21 is used for detecting at least one first touch point and at least one second touch point and further determining a vector difference between the at least one first touch point and the at least one second touch point. The processing module 24 coupled to the detecting module 22 is used for executing a first command according to the first touch point, and executing a second command according to the vector difference and the first command.

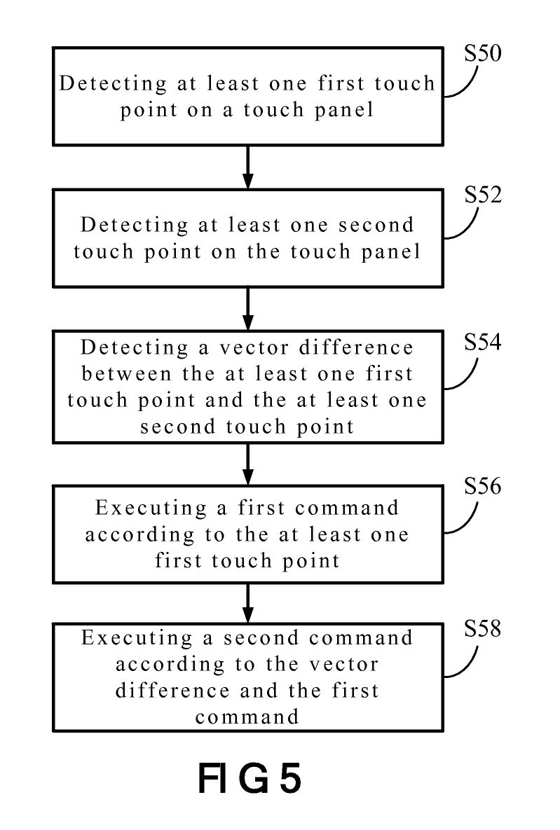

Please refer to FIGS. 2, 3 and 4, FIG. 3 is a schematic diagram of an embodiment of a vector difference of the electronic apparatus with touch panel according to the present invention. FIG. 4 is a schematic diagram of another embodiment of the vector difference of the electronic apparatus with touch panel according to the present invention. As shown in FIGS. 2 to 4, in one embodiment, the vector difference is generated by one or more of the at least one touch point T1 and the at least one second touch point T2 occurring a position variation. The position variation is caused by one of a moving, slipping, dragging and rotating gestures executed on one or more than one of the at least one first touch point T1 and the at least one second touch point T2.

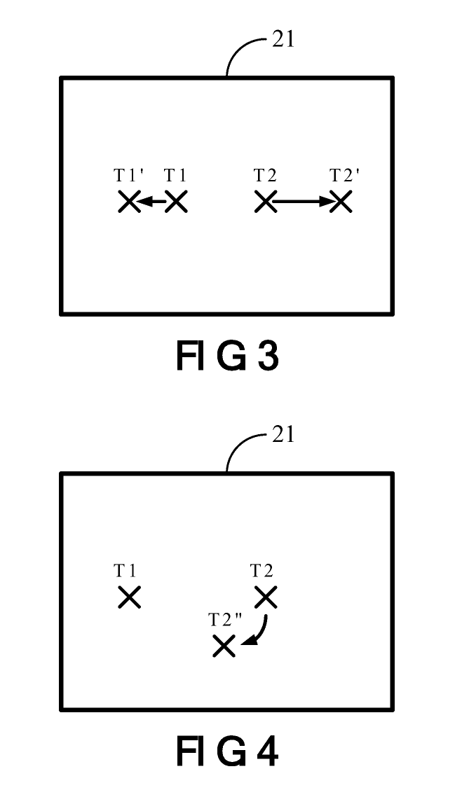

After the at least one second touch point T2 on the touch panel 21 is detected by the detecting module 22, the detecting module 22 further determines a first vector between the at least one first touch point T1 and the at least one second touch point T2, and then continued detects a second vector between the at least one first touch point T1 and the at least one second touch point T2 generated by one or more touch points of the at least one first touch point T1 and the at least one second touch point T2 occurring the position variation. Furthermore, the detecting module 22 generates the vector difference according to the first vector and the second vector. Please continued refer to FIGS. 3 and 4, when detecting module 22 determines the first vector between the at least one first touch point T1 and the at least one second touch point T2, the detecting module 22 further detects whether a position variation exists of the at least one first touch point T1 or the at least one second touch point T2 or not. Taking FIG. 3 for example, a position variation caused by the first touch point T1 moving to a new position T1′ and the second touch point T2 moves to a new position T2′ respectively, the detecting module 22 determines the second vector between the first touch point T1 on the new position T1′ and the second touch point T2 on the new position T2′ accordingly, and further determines the vector difference according to the first vector and the second vector. When the at least one first touch point T1 and the at least one second touch point T2 moves to the new positions T1′ and T2′ respectively, there is a vector difference exists because the vector has been changed between the at least one first touch point T1 and the at least one second touch point T2 correspondingly. When the detecting module 22 detects the position variation and further determines the vector difference, the processing module 24 executes the second command for scaling up an image or a word displayed on the touch panel 21. As shown as FIG. 4, When the at least one first touch point T1 is fixed and only the at least one second touch point T2 moves to the new position T2′, it also causes a vector difference between the at least one first touch point T1 and the at least one second touch point T2. It is considered that the user operates a touch gesture on the touch panel 21 by the electronic apparatus 20 because of it exists a vector difference on the touch panel 21 correspondingly. The second command generated by the processing module 24 is used for rotating the image object or the word displayed on the touch panel 21 as this example as shown in FIG. 4. The embodiment described above doesn't limit which one of the at least one first touch point T1 and the at least one second touch point T2 moving or not, the vector difference caused by any one of the touch points T1 and T2 moving from a initial position to a new position for generating the position variation can be considered to the vector difference of the detecting module 22 of the electronic apparatus 20 with touch panel 21 of this invention.

In one embodiment, the detecting module 22 further comprises a counting unit 221 for counting the at least one first touch point T1 or the at least one second touch point T2 is detected by the detecting module 22. The detecting module 22 detects the at least one second touch point T2 on the touch panel 21 during a predetermined time period after the at least one first touch point T1 is detected. If the at least one second touch point T2 does not exist on the touch panel 21 during the predetermined time period after the at least one first touch point T1 is detected, the detecting module 22 finishes the detecting action and determines that there is only the at least one first touch point T1 on the touch panel 21. In the same manner, the detecting module 22 detects the vector difference between the at least one touch point T1 and the at least one second touch point T2 during a predetermined time period after it detected the at least one second touch point T2 existed on the touch panel 21. If there is no vector difference, the detecting module 22 determines that only the first touch point T1 and second touch point T2 exist on the touch panel 21 but no any position variation of those two point touch point T1 and T2.

In one embodiment, when the position of the at least one touch point T1 matches an image object displayed on the touch panel 21, the first command generated by the processing module 24 is used for selecting the image object displayed on the touch panel 21. In this condition, the second command generated by the processing module 24 is used for scaling, rotating, adjusting, pointing or moving the image object. As the embodiments shown in FIGS. 3 and 4, the second command is used for scaling and rotating the image object displayed on the touch panel 21 respectively.

In another embodiment, the processing module 24 further comprises a storage unit 241 used for storing a plurality of function actions corresponding to the vector difference. In this embodiment, the first command is used for controlling the touch panel 21 into a function selection mode and the second command is used for executing a corresponding function action of the plurality of function actions according to the vector difference under the function selection mode. In this embodiment, when the user operates a gesture on the touch panel 21, the electronic apparatus 20 executes the storing function actions correspondingly, just like the function key or the hot key used in general computer systems.

Please refer to FIG. 5. FIG. 5 is a flowchart diagram of an embodiment of operating method of electronic apparatus with touch panel according to the present invention. As shown in FIG. 5, another embodiment of the present invention provides an operating method of electronic apparatus with touch panel comprising following steps:

Step 50: detecting at least one first touch point on a touch panel;

Step 52: detecting at least one second touch point on the touch panel. In one embodiment, this step detects the at least one second touch point on the touch panel during a predetermined time period after the at least one touch point is detected. If the at least one second touch point is not detected during the predetermined time period, this step does not execute and the operating method returns to the step S50.

Step 54: determining a vector difference between the at least one first touch point and the at least one second touch point. This step of the operating method detects the vector difference between the at least one first touch point and the at least one second touch point during a predetermined time period after the at least one second touch point is detected by the step S52. If the at least one second touch point is not detected during the predetermined time period, the operation method returns to step S52.

S56: executing a first command according to the at least one touch point; and

S58: executing a second command according to the vector difference and the first command.

In one embodiment, the vector difference generated by a position variation caused by one of a moving, slipping, dragging and rotating gestures executed to the at least one touch point and the at least one second touch point. The operating method of electronic apparatus with touch panel determines a first vector between the at least one first touch point and the at least one second touch point after the at least one second touch point is detected, it also determines a second vector between the at least one first touch point and the at least one second touch point generated by one or more points of the at least one first touch point and the at least one second touch point occurring the position variation, and then determines the vector difference according to the first vector and the second vector.

In one embodiment, if the position of the at least one first touch point matches an image object displayed on the touch panel, the first command is used for selecting the image object displayed on the touch panel. Correspondingly, the second command is used for scaling, rotating, adjusting, pointing or moving the selected image object. In another embodiment, the first command controls the touch panel into a function selection mode and the second command is used for executing one of a plurality of function actions stored in a storage unit according to the vector difference under the function selection mode.

As mentioned above, the electronic apparatus with touch panel and the operating method therefor detects multi-touch executed by the user on the touch panel with multi-touch function, it determines the vector difference between two touch points and controls the electronic apparatus to execute a corresponding function action according to the vector difference. The electronic apparatus with touch panel of this invention provides a fast and convenient operation via the operation characteristics of the touch panel with multi-touch function and further provides the electronic apparatus with touch panel with a new operation mode.

Those skilled in the art will readily observe that numerous modifications and alterations of the apparatus and the method may be made while retaining the teachings of the invention. Accordingly, the above disclosure should be construed as limited only by the metes and bounds of the appended claims.

What is claimed is:

1. An electronic apparatus with touch panel, comprising:
a touch panel;
a detecting module coupled to the touch panel for detecting at least one first touch point and at least one second touch point on the touch panel, and further detecting a vector difference between the at least one first touch point and the at least one second touch point; and
a processing module coupled to the detecting module for executing a first command according to the at least one first touch point and executing a second command according to the vector difference and the first command.

2. The electronic apparatus with touch panel of claim 1, wherein the vector difference is generated by one or more of the at least one first touch point and the at least one second touch point occurring a position variation.

3. The electronic apparatus with touch panel of claim 2, wherein the position variation is caused by one of a moving, slipping, dragging and rotating gestures executed to the at least one first touch point and the at least one second touch point.

4. The electronic apparatus with touch panel of claim 3, wherein the detecting module determines a first vector between the at least one first touch point and the at least one second touch point after the at least one second touch point is detected, and further determines a second vector between the at least one first touch point and the at least one second touch point generated by one or more touch points of the at least one first touch point and the at least one second touch point occurring the position variation, and then determines the vector difference according to the first vector and the second vector.

5. The electronic apparatus with touch panel of claim 1, wherein the detecting module further comprises a counting unit for counting a time period after the at least one first touch point and the at least one second touch point is detected by the detecting module respectively.

6. The electronic apparatus with touch panel of claim 5, wherein the detecting module detects the at least one second touch point on the touch panel during a predetermined time period after the at least one first touch point is detected.

7. The electronic apparatus with touch panel of claim 5, wherein the detecting module detects the vector difference between the at least one touch point and the at least one second touch point during a predetermined time period after the at least one second touch point is detected.

8. The electronic apparatus with touch panel of claim 1, wherein when the position of the at least one first touch point matches an image object displayed on the touch panel, the first command is used for selecting the image object displayed on the touch panel.

9. The electronic apparatus with touch panel of claim 8, wherein the second command is used for scaling, rotating, adjusting, pointing or moving the image object.

10. The electronic apparatus with touch panel of claim 1, wherein the first command controls the touch panel into a function selection mode.

11. The electronic apparatus with touch panel of claim 10, wherein the processing module comprises a storage unit for storing a plurality of function actions corresponding to the vector difference and the second command is used for executing a corresponding function action of the plurality of function actions according to the vector difference under the function selection mode.

12. An operating method for electronic apparatus with touch panel, which comprising following steps:
(a) detecting at least one first touch point on a touch panel;
(b) detecting at least one second touch point on the touch panel;
(C) determining a vector difference between the at least one first touch point and the at least one second touch point;
(d) executing a first command according to the at least one first touch point; and
(e) executing a second command according to the vector difference and the first command.

13. The operating method for the electronic apparatus with touch panel of claim 12, wherein the vector difference is generated by one of the at least one first touch point or the at least one second touch point occurring a position variation.

14. The operating method of electronic apparatus with touch panel of claim 13, wherein the position variation is caused by one of a moving, slipping, dragging and rotating gestures executed to the at least one first touch point or the at least one second touch point.

15. The operating method of electronic apparatus with touch panel of claim 14, wherein the method comprises steps:
(c1)determining a first vector between the at least one first touch point and the at least one second touch point after the at least one second touch point is detected;
(c2) determining a second vector between the at least one first touch point and the at least one second touch point generated by one or more points of the at least one first touch point and the at least one second touch point occurring the position variation; and
(c3) determining the vector difference according to the first vector and the second vector.

16. The operating method of electronic apparatus with touch panel of claim 12, wherein the method further detects the at least one second touch point on the touch panel during a predetermined time period after the at least one first touch point is detected.

17. The operating method of electronic apparatus with touch panel of claim 12, wherein the method detects the vector difference between the at least one first touch point and the at least one second touch point during a predetermined time period after the at least one second touch point is detected.

18. The operating method of electronic apparatus with touch panel of claim 12, wherein when the position of the at least one first touch point matches an image object displayed on the touch panel, the first command is used for selecting the image object displayed on the touch panel.

19. The operating method of electronic apparatus with touch panel of claim 18, wherein the second command is used for scaling, rotating, adjusting, pointing or moving the image object.

20. The operating method of electronic apparatus with touch panel of claim 12, wherein the first command controls the touch panel into a function selection mode and the method further stores a plurality of function actions according to the vector difference and the second command is used for executing a corresponding function action of the plurality of function actions according to the vector difference under the function selection mode.
